(19) United States
(12) Patent Application Publication
(10) Pub. No.: US 2023/0373342 A1
(43) Pub. Date: Nov. 23, 2023

(54) CHARGE SUPPORT SYSTEM AND CHARGE SUPPORT METHOD

(71) Applicant: HONDA MOTOR CO., LTD., Tokyo (JP)

(72) Inventors: Toru Kimura, OFFENBACH/AM MAIN (DE); Martin Kopp, OFFENBACH/AM MAIN (DE); Christian Koebel, OFFENBACH/AM MAIN (DE); Hisashi Nagaoka, OFFENBACH/AM MAIN (DE)

(21) Appl. No.: 18/307,336

(22) Filed: Apr. 26, 2023

(30) Foreign Application Priority Data
May 19, 2022 (JP) 2022-082328

(51) Int. Cl. B60L 53/68

(52) U.S. Cl. CPC B60L 53/68; B60L 2240/70; B60L 2250/20

(57) ABSTRACT

A charge support system includes: a manager information acquiring section that acquires manager information as information regarding a manager of a private charge facility; an applicant-for-use information acquiring section that acquires applicant-for-use information as information regarding an applicant for use who wants to use the private charge facility; and a permission-for-charge-facility-use determining section that determines whether or not a predetermined permission-for-use condition is established between the applicant for use and the manager based on the applicant-for-use information and the manager information upon receipt of application-for-charge-facility-use information from a user terminal, the application-for-charge-facility-use information being for applying for use of the private charge facility, and that transmits permission-for-use information to the user terminal when the permission-for-use condition is established, the permission-for-use information being for making notification of permission for use of the private charge facility.

### INCORPORATION BY REFERENCE

The present application claims priority under 35 U.S.C. § 119 to Japanese Patent Application No. 2022-082328 filed on May 19, 2022. The content of the application is incorporated herein by reference in its entirety.

### BACKGROUND OF THE INVENTION

### Field of the Invention

The present invention relates to a charge support system and a charge support method.

### Description of the Related Art

Research and development regarding power charge and supply in vehicles that have secondary batteries mounted thereon, which contribute to optimization of energy, have been recently being conducted in order to enable more people to secure reasonable and reliable access to sustainable and advanced energy.

For example, there is proposed a technology of enabling a charge apparatus installed on a house to be switched between a personal mode and a publicly open mode, the personal mode restricting the usage to specific user(s), the publicly open mode allowing the usage of general user(s) (for example, see Japanese Patent Laid-Open No. 2019-221014). Moreover, there is proposed a technology of calculating a remaining travelable distance based on speed information of an electric vehicle and change in battery information over time and of extracting charge station(s) within the remaining travelable distance based on position information (for example, see Japanese Patent Laid-Open No. 2011-102739).

Now, concerning technologies regarding power charge and supply in vehicles having secondary batteries mounted, in order to promote the spread of electric movable bodies, it is effective to permit a general user other than residents in a house to use a private charge facility installed on the house or the like as with the aforementioned conventional technology. However, it is supposed that a manager of the private charge facility, such as an owner of the house, possibly feels resistance against allowing any of unspecified public users to use the private charge facility. Therefore, a problem to be solved with the present application is to relieve the manager of the private charge facility from feeling such resistance.

In order to solve the aforementioned problem, an object of the present application is to enable a general user to use a private charge facility installed on a house or the like with a manager of the private charge facility relieved from feeling resistance, and thereby contribute to optimization of energy.

### SUMMARY OF THE INVENTION

There is exemplified as a first aspect in order to achieve the aforementioned object a charge support system including: a manager information acquiring section that accesses a manager database that stores manager information as information regarding a manager of a private charge facility to acquire the manager information; an applicant-for-use information acquiring section that accesses a user database that stores applicant-for-use information as information regarding an applicant for use who wants to use the private charge facility to acquire the applicant-for-use information; and a permission-for-charge-facility-use determining section that determines whether or not a predetermined permission-for-use condition is established between the applicant for use and the manager based on the applicant-for-use information and the manager information upon receipt of application-for-charge-facility-use information from a user terminal used by the applicant for use, the application-for-charge-facility-use information being for applying for use of the private charge facility, and that transmits permission-for-use information to the user terminal when the permission-for-use condition is established, the permission-for-use information being for making notification of permission for use of the private charge facility.

Herein, the private charge facility is not a public charge facility with unspecified public users being as its targets but means a personally owned charge facility such as a charge facility that an owner of a house installs in a site of the house.

There may be employed a configuration according to the aforementioned charge support system, wherein the applicant-for-use information includes information of a provider of a first electric device that the applicant for use wants to charge with the private charge facility, the manager information includes information of a provider of the private charge facility or a second electric device that is used by the manager, and the permission-for-use condition to the effect that the provider of the first electric device and the provider of the private charge facility or the second electric device are identical is set.

There may be employed a configuration according to the aforementioned charge support system, wherein the applicant-for-use information includes identification information of the applicant for use, the manager information includes identification information of a subject person that the manager has previously permitted to use the private charge facility, and the permission-for-use condition to the effect that the identification information of the applicant for use coincides with the identification information of the subject person that the manager has previously permitted to use the private charge facility is set.

There may be employed a configuration according to the aforementioned charge support system, wherein the applicant-for-use information includes an attribute of the applicant for use, the manager information includes an attribute of the manager, and the permission-for-use condition to the effect that at least one element is common to the attribute of the applicant for use and the attribute of the manager is set.

There may be employed a configuration according to the aforementioned charge support system, wherein the application-for-charge-facility-use information includes information of a place where the applicant for use is positioned, the manager information includes information of a place where the private charge facility is installed, and the permission-for-charge-facility-use determining section determines whether or not the permission-for-use condition is established with the private charge facility that is installed at a place within a predetermined distance from the place where the applicant for use is positioned being as a target.

There may be employed a configuration according to the aforementioned charge support system, wherein the private charge facility is a facility for charging an electric vehicle, the configuration including a charge facility usage situation recognizing section that recognizes a usage situation of the private charge facility, wherein when the permission-for-use condition is established and the charge facility usage situation recognizing section recognizes that there is a vacant parking space for using the private charge facility, the permission-for-charge-facility-use determining section transmits the permission-for-use information to the user terminal.

There is exemplified as a second aspect in order to achieve the aforementioned object a charge support method executed by a computer, the method including: a manager information acquiring step of accessing a manager database that stores manager information as information regarding a manager of a private charge facility to acquire the manager information; an applicant-for-use information acquiring step of accessing a user database that stores applicant-for-use information as information regarding an applicant for use who wants to use the private charge facility to acquire the applicant-for-use information; and a permission-for-charge-facility-use determining step of determining whether or not a predetermined permission-for-use condition is established between the applicant for use and the manager based on the applicant-for-use information and the manager information upon receipt of application-for-charge-facility-use information from a user terminal used by the applicant for use, the application-for-charge-facility-use information being for applying for use of the private charge facility, and of transmitting permission-for-use information to the user terminal when the permission-for-use condition is established, the permission-for-use information being for making notification of permission for use of the private charge facility.

According to the aforementioned charge support system, a general user can be enabled to use a charge facility installed on a house while relieving a manager of the charge facility from felling resistance.

### BRIEF DESCRIPTION OF THE DRAWINGS

FIG. 1 is an explanatory diagram of an aspect of usage support of a private charge facility by a charge support system and a configuration of the charge support system;

FIG. 2 is a first flowchart of usage support processing of the private charge facility; and

FIG. 3 is a second flowchart of usage support processing of the private charge facility.

### DETAILED DESCRIPTION OF THE PREFERRED EMBODIMENTS

### 1. Aspect of Usage Support of Charge Facility by Charge Support System

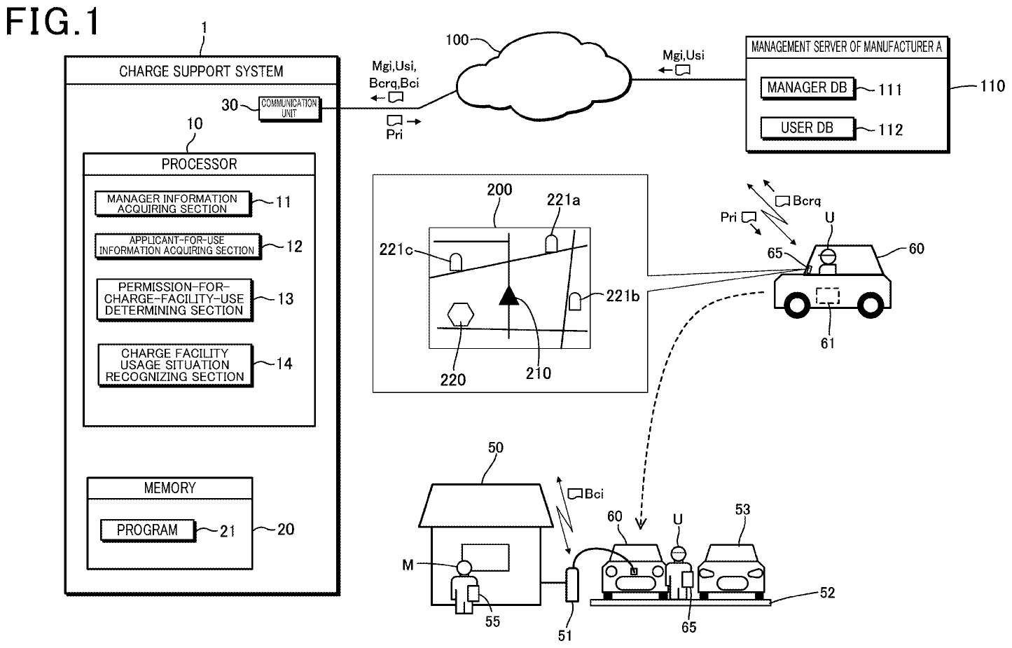

Referring to FIG. 1, there are described a configuration of a charge support system 1 of the present embodiment, and an aspect of usage support, of a private charge facility 51, that is performed by the charge support system 1. The charge support system 1 is a computer system including a processor 10, a memory 20, a communication unit 30 (transmitter/receiver, circuit), and the like. FIG. 1 exemplarily illustrates a situation that the charge support system 1 matches a private charge facility 51 installed in a site of a house 50 with an applicant for use U who wants to charge an electric vehicle 60, and permits the applicant U as a general user to use the private charge facility 51.

The electric vehicle 60 is an electric vehicle, a plug-in hybrid car, or the like which includes a battery 61 for travelling. The charge support system 1 communicates with a user terminal 65 used by the applicant U, a manager terminal 55 used by a manager M of the private charge facility 51, a management server 110 (computer) of a manufacturer A, the private charge facility 51, and the like, by means of the communication unit 30 via a communication network 100. Each of the user terminal 65 and the manager terminal 55 is a smartphone, a tablet terminal, a cellular phone, or the like. Notably, the user terminal 65 may be a communication terminal mounted on the electric vehicle 60.

The manager M is an owner of the house 50 or a user of the house 50 on lease, and manages use of the private charge facility 51. The manager M owns an electric vehicle 53 or uses it on lease. The manufacturer A is a manufacturer of the electric vehicles 53 and 60 and the private charge facility 51 and corresponds to a provider of a private charge facility and an electric device of the present disclosure. The electric device of the present disclosure may be an electric vehicle, or other than this, a flying vehicle, a vessel, a portable power supply or the like that can be charged with the private charge facility 51. Moreover, the provider may be a sales company such as a dealer of a charge facility and an electric device, or a provider company that lends a charge facility and an electric product.

The management server 110 of the manufacturer A includes, in a memory, a manager DB (database) 111 that stores manager information Mgi as information regarding a manager of a charge facility that is produced and provided by the manufacturer A, and a user DB 112 that stores user information Usi as information regarding a user of an electric vehicle that is produced and provided by the manufacturer A.

The manager information Mgi is generated in accordance with a procedure of application for registration of a private charge facility by a manager. The manager information includes a membership number of the manager issued by the management server 110 of the manufacturer A, information of the private charge facility managed by the manager, and information of the manager. The information of the private charge facility includes a model name, contract information, and maintenance information of the private charge facility, and the like. The information of the manager includes the name and the address of the manager, the actual results of lending the private charge facility that the manager has ever made and the degree of cooperation in the lending, attributes of the manager (birthplace, living area, occupation, hobby, and the like), and the like.

The user information Usi is generated in accordance with a procedure of application for registration of an electric vehicle by a user. The user information Usi includes a membership number of the user issued by the management server 110 of the manufacturer A, a vehicle model of the electric vehicle used by the user, the name and the address of the user, the actual results of using the private charge facility that the user has ever made, evaluation on the user made by the manager of the private charge facility that the user has used before, attributes of the user (birthplace, living area, occupation, hobby, and the like), and the like.

The applicant U executes a charge-matching application (application program) installed in the user terminal 65 to transmit, to the charge support system 1, application-for-charge-facility-use information Bcrq for applying for use of a private charge facility existing near a place where the applicant U is positioned. The application-for-charge-facility-use information Bcrq includes identification information of the applicant U (the membership number and the name of the applicant U) and information of a current position of the applicant U detected by a position sensor included in the user terminal 65.

In response to reception of the application-for-charge-facility-use information Bcrq, the charge support system 1 refers to the manager DB 111 and the user DB 112, and receives usage situation information Bci indicating a usage situation of the private charge facility 51 transmitted from the private charge facility 51. Then, the charge support system 1 confirms that the applicant U is the user of the electric vehicle 60 produced by the manufacturer A, and extracts available private charge facility(es), produced by the manufacturer A, that exist(s) within a predetermined distance from the current position of the applicant U. Then, the charge support system 1 transmits information of the extracted private charge facility(es) to the user terminal 65.

In the user terminal 65 receiving the information of charge facilities, the charge-matching application displays, on a display unit, a guidance screen 200 indicating positions of charge facilities existing near the applicant U (public charge facilities and private charge facilities). On the guidance screen 200, there are displayed an icon 210 indicating the position of the applicant U (position of the electric vehicle 60), an icon 220 indicating the position of a public charge facility, and icons 221a to 221c indicating the positions of private charge facilities installed in sites of ordinary houses and the like.

The applicant U examines the guidance screen 200, and when the applicant wants to use a private charge facility, makes a selecting manipulation for any of the icons 221a to 221c. In response to the selecting manipulation, selection information of the private charge facility is transmitted from the user terminal 65 to the charge support system 1. FIG. 1 shows a case where the private charge facility 51 is selected. In this case, the charge support system 1 transmits, to the manager terminal 55, usage confirmation information of asking whether or not use (use on lease) of the private charge facility 51 by the applicant U is permitted.

Then, upon receipt of permission-for-use information of permitting the applicant U to use the private charge facility 51 from the manager terminal 55, the charge support system 1 transmits availability information Pri to the user terminal 65. The applicant U confirms a permission-for-use screen for the private charge facility 51 displayed on the display unit of the user terminal 65 in response to reception of the availability information Pri, and can move to the installation place of the private charge facility 51 and charge the electric vehicle 60 with the private charge facility 51.

As above, the charge support system 1 matches the manager M using the private charge facility 51 produced by the manufacturer A with the applicant U using the electric vehicle 60 produced by the manufacturer A to support the applicant U to use the private charge facility 51. In this case, it can be expected that by virtue of the manager M feeling familiar with the applicant U using a product of the same manufacturer A, there is relieved the manager M from feeling resistance against allowing the applicant U to use the charge facility.

### 2. Configuration of Charge Support System

Referring to FIG. 1, a configuration of the charge support system 1 is described. The processor 10 included in the charge support system 1 functions as a manager information acquiring section 11, an applicant-for-use information acquiring section 12, a permission-for-charge-facility-use determining section 13, and a charge facility usage situation recognizing section 14 by reading and executing a program 21 stored in the memory 20.

Processing performed by the manager information acquiring section 11 corresponds to a manager information acquiring step in a charge support method of the present disclosure, and processing performed by the applicant-for-use information acquiring section 12 corresponds to an applicant-for-use information step in the charge support method of the present disclosure. Processing performed by the permission-for-charge-facility-use determining section 13 corresponds to a permission-for-charge-facility-use determining step in the charge support method of the present disclosure, and processing performed by the charge facility usage situation recognizing section 14 corresponds to a charge facility usage situation recognizing step in the charge support method of the present disclosure.

The manager information acquiring section 11 acquires the manager information Mgi of a manager (FIG. 1 exemplarily illustrates the manager M) stored in the manager DB 111, by accessing the manager DB 111 of the management server 110 of the manufacturer A through the communication unit 30. The applicant-for-use information acquiring section 12 acquires the user information Usi of the applicant U (hereinafter also referred to as applicant-for-use information Usi) stored in the user DB 112, by accessing the user DB 112 of the management server 110 of the manufacturer A through the communication unit 30.

The permission-for-charge-facility-use determining section 13 permits the applicant U to use (use on lease) the private charge facility 51 under a condition that a predetermined permission-for-use condition is established between the manager M of the private charge facility 51 and the applicant U of the private charge facility 51. In the present embodiment, it is set, as the permission-for-use condition, that both the private charge facility 51 managed by the manager M and the electric vehicle 60 used by the applicant U are products of the manufacturer A. The permission-for-charge-facility-use determining section 13 recognizes that the manager M is a manager of the private charge facility 51 produced by the manufacturer A and the applicant U is a user of the electric vehicle 60 produced by the manufacturer A, based on the manager information Mgi of the manager M acquired by the manager information acquiring section 11 and the applicant-for-use information Usi of the applicant U acquired by the applicant-for-use information Usi.

The charge facility usage situation recognizing section 14 recognizes the usage situation information Bci. The usage situation information Bci of the private charge facility 51 transmitted from the private charge facility 51 includes information indicating whether or not the private charge facility 51 is being used and whether or not a parking space 52 is vacant. The information indicating whether or not the parking space 52 is vacant is, for example, an image obtained by capturing the parking space 52 with a camera provided in the private charge facility 51.

### 3. Usage Support Processing for Private Charge Facility

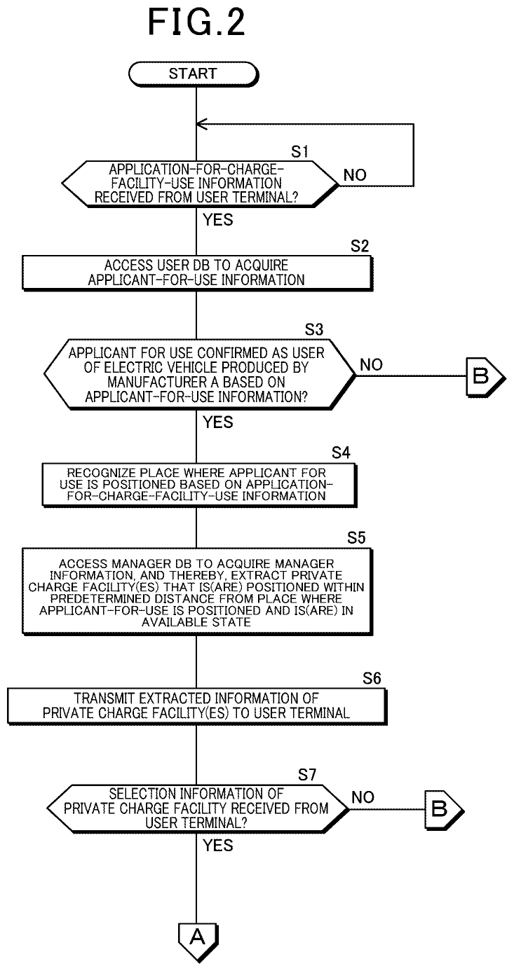

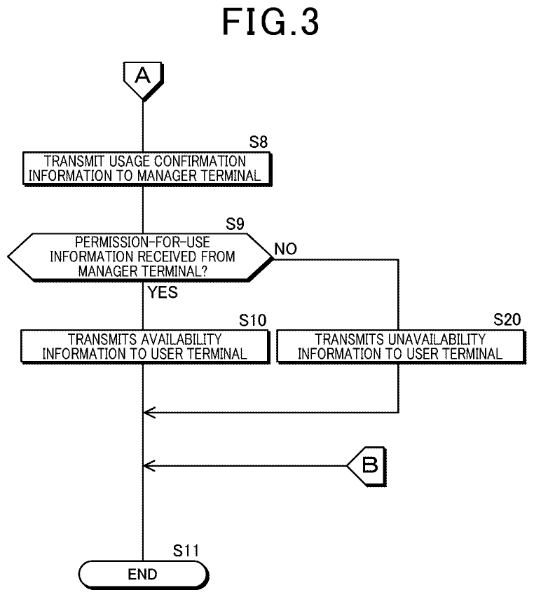

In accordance with flowcharts shown in FIG. 2 and FIG. 3, there is described a procedure of usage support processing for the private charge facility 51 performed by the charge support system 1 in the situation exemplarily illustrated in FIG. 1.

In step S1 of FIG. 2, upon receipt of the application-for-charge-facility-use information Bcrq transmitted from the user terminal 65, the permission-for-charge-facility-use determining section 13 puts the process forward to step S2. In step S2, the applicant-for-use information acquiring section 12 accesses the user DB 112 of the management server 110 of the manufacturer A through the communication unit 30 to acquire the applicant-for-use information Usi of the applicant U stored in the user DB 112.

Subsequently in step S3, when it is confirmed that the applicant U is a user of the electric vehicle 60 produced by the manufacturer A based on the applicant-for-use information Usi, the permission-for-charge-facility-use determining section 13 puts the process forward to step S4. On the other hand, when it is not confirmed that the applicant U is a user of the electric vehicle 60 produced by the manufacturer A, the permission-for-charge-facility-use determining section 13 puts the process forward to step S12 of FIG. 3, and in this case, there is not performed processing in and after step S4 for matching the private charge facility 51 with the applicant U. In this case, in the user terminal 65, the charge-matching application may display a guidance screen for public charge facilities on the display unit.

Subsequently in step S5, the manager information acquiring section 11 accesses the manager DB 111 of the management server 110 of the manufacturer A through the communication unit 30 to acquire the manager information Mgi of private charge facilities stored in the manager DB 111. Next in step S6, based on the information of the current position of the applicant U included in the application-for-charge-facility-use information Bcrq and addresses of managers included in the manager information Mgi, the permission-for-charge-facility-use determining section 13 extracts private charge facility(es), produced by the manufacturer A, that is(are) positioned at place(s) within a predetermined distance from the current position of the applicant U.

Furthermore, based on the usage situation of each private charge facility recognized by the charge facility usage situation recognizing section 14, the permission-for-charge-facility-use determining section 13 extracts private charge facility(es) that is(are) positioned at place(s) within the predetermined distance from the current position of the applicant U and is(are) in the available state (state where each charge facility is not used and there is a vacant parking space).

Next in step S7, the permission-for-charge-facility-use determining section 13 transmits the information of the private charge facility(es) extracted in step S6 to the user terminal 65. Thereby, as mentioned above with reference to FIG. 1, the guidance screen 200 for charge facilities is displayed on the display unit of the user terminal 65. Subsequently in step S8, upon receipt of the selection information of a private charge facility transmitted from the user terminal 65, the permission-for-charge-facility-use determining section 13 puts the process forward to step S9 of FIG. 3, and when the selection information of a private charge facility is not received, it puts the process forward to step S12 of FIG. 3.

There is hereafter described a case where the applicant U selects the private charge facility 51 installed in the site of the house 50 as shown in FIG. 1. In step S9 of FIG. 3, the permission-for-charge-facility-use determining section 13 transmits usage confirmation information for confirming whether or not the applicant U is permitted to use the private charge facility 51 to the manager terminal 55. The usage confirmation information includes information for making notification that the applicant U is the user of the electric vehicle 60 produced by the manufacturer A. Notably, the usage confirmation information may include information regarding the electric vehicle 60 such as the vehicle model, the color, the registration number, and the like of the electric vehicle 60.

Subsequently in step S10, upon receipt of the permission-for-use information indicating permission for use of the private charge facility 51 transmitted from the manager terminal 55, the permission-for-charge-facility-use determining section 13 puts the process forward to step S11, and when the permission-for-use information is not received, it puts the process forward to step S20. In step S11, the permission-for-charge-facility-use determining section 13 transmits, to the user terminal 65, the availability information Pri for making notification of permission for use of the private charge facility 51.

In the user terminal 65 having received the availability information Pri, the charge-matching application displays, on the display unit, a guidance screen indicating that the private charge facility 51 is available. The applicant U confirming this guidance screen can move to the installation place of the private charge facility 51 and charge the electric vehicle 60 with the private charge facility 51.

Otherwise, in the user terminal 65 receiving unavailability information, the charge-matching application displays, on the display unit, a guidance screen indicating that the private charge facility 51 is unavailable. The applicant U confirming this guidance screen considers to use another charge facility.

### 4. Other Embodiments

While in the aforementioned embodiment, there has been presented an example that a charge support system of the present disclosure is constituted of a computer system, a part or the entirety of the configuration of the charge support system may be constituted of the user terminal 65. In this case, by executing a program stored in a memory included in the user terminal 65 with a processor included in the user terminal 65, the processor included in the user terminal 65 functions as the manager information acquiring section 11, the applicant-for-use information acquiring section 12, the permission-for-charge-facility-use determining section 13, and the like. Further, the user terminal 65 communicates with the management server 110 of the manufacturer A, the manager terminal 55, and the private charge facility 51 via the communication network 100, and thereby, performs processing of matching the manager M of the private charge facility 51 with the applicant U.

While in the aforementioned embodiment, it is set, as a permission-for-use condition of the present disclosure, that the electric vehicle 60 used by the applicant U and the private charge facility 51 managed by the manager M has the same provider, there may be set, as another permission-for-use condition, for example, any of conditions (1) to (3) below. (1) The electric vehicle 60 (corresponding to a first electric device of the present disclosure) used by the applicant U and the electric vehicle 53 (corresponding to a second electric device of the present disclosure) used by the manager M has the same provider (manufacture company, sales company or the like). (2) The applicant U has the actual result(s) of previously using the private charge facility 51 managed by the manager M. It should be noted that this condition is not established in the case of low evaluation by the manager M with respect to the applicant U previously using the private charge facility 51. (3) At least one element is common to the attribute of the applicant U and the attribute of the manager M. Examples of elements of the attribute are a birthplace, a living area, a hobby, and the like.

While in the aforementioned embodiment, the permission-for-charge-facility-use determining section 13 extracts private charge facility(es) existing within a predetermined distance from the place where the applicant U is positioned, there may be employed a configuration of extracting private charge facility(es) in no consideration of the distance from the place where the applicant U is positioned.

While in the aforementioned embodiment, the charge facility usage situation recognizing section 14 is included and the permission-for-charge-facility-use determining section 13 extracts the private charge facility 51 under the condition that there is a vacant parking space for using the private charge facility 51, there may be employed a configuration in which the charge facility usage situation recognizing section 14 is omitted. In this case, the manager M having made permission for use of the private charge facility 51 may move a vehicle owned by the manager M to make a vacant parking space for the applicant U.

Notably, FIG. 1 is a schematic diagram having the functional configurations of the charge support system 1 sectioned by major processing operations for ease of understanding of the invention as claimed in the present application, the configurations of the charge support system 1 may be sectioned on another basis. Moreover, processing of the sections may be performed by one hardware unit or may be performed by a plurality of hardware units. Moreover, processing of the sections shown in FIG. 2 to FIG. 3 may be performed by one program or may be performed by a plurality of programs.

### 5. Configurations Supported by Aforementioned Embodiment

The aforementioned embodiment is a specific example of the following configurations.

(Configuration 1) A charge support system including: a manager information acquiring section that accesses a manager database that stores manager information as information regarding a manager of a private charge facility to acquire the manager information; an applicant-for-use information acquiring section that accesses a user database that stores applicant-for-use information as information regarding an applicant for use who wants to use the private charge facility to acquire the applicant-for-use information; and a permission-for-charge-facility-use determining section that determines whether or not a predetermined permission-for-use condition is established between the applicant for use and the manager based on the applicant-for-use information and the manager information upon receipt of application-for-charge-facility-use information from a user terminal used by the applicant for use, the application-for-charge-facility-use information being for applying for use of the private charge facility, and that transmits permission-for-use information to the user terminal when the permission-for-use condition is established, the permission-for-use information being for making notification of permission for use of the private charge facility.

According to the charge support system of Configuration 1, a general user can be enabled to use a charge facility installed on a house while relieving a manager of the charge facility from feeling resistance.

(Configuration 2) The charge support system according to Configuration 1, wherein the applicant-for-use information includes information of a provider of a first electric device that the applicant for use wants to charge with the private charge facility, the manager information includes information of a provider of the private charge facility or a second electric device that is used by the manager, and the permission-for-use condition to the effect that the provider of the first electric device and the provider of the private charge facility or the second electric device are identical is set.

According to the charge support system of Configuration 2, when it is expected that the manager feels familiar with the applicant for charge since there are identical the provider of the first electric device that the applicant for use wants to charge with the charge facility and the provider of the charge facility or the second electric device used by the manager, the applicant for use can be permitted to use the charge facility. Herein, examples of the provider include a manufacture company (manufacturer), a sales company (dealer), and the like of the electric devices and the charge facility.

(Configuration 3) The charge support system according to Configuration 1 or 2, wherein the applicant-for-use information includes identification information of the applicant for use, the manager information includes identification information of a subject person that the manager has previously permitted to use the private charge facility, and the permission-for-use condition to the effect that the identification information of the applicant for use coincides with the identification information of the subject person that the manager has previously permitted to use the private charge facility is set.

According to the charge support system of Configuration 3, the applicant for use who has the actual result(s) of previously using the charge facility can be permitted to use the charge facility.

(Configuration 4) The charge support system according to any one of Configuration 1 to Configuration 3, wherein the applicant-for-use information includes an attribute of the applicant for use, the manager information includes an attribute of the manager, and the permission-for-use condition to the effect that at least one element is common to the attribute of the applicant for use and the attribute of the manager is set.

According to the charge support system of Configuration 4, when it is expected that the manager feels familiar with the applicant for use since the manager and the applicant for use have a common attribute element, the applicant for use can be permitted to use the charge facility.

(Configuration 5) The charge support system according to any one of Configuration 1 to Configuration 4, wherein the application-for-charge-facility-use information includes information of a place where the applicant for use is positioned, the manager information includes information of a place where the private charge facility is installed, and the permission-for-charge-facility-use determining section determines whether or not the permission-for-use condition is established with the private charge facility that is installed at a place within a predetermined distance from the place where the applicant for use is positioned being as a target.

According to the charge support system of Configuration 5, it can be determined to permit or not to permit usage with a charge facility that exists near the applicant for use being as a target.

(Configuration 6) The charge support system according to any one of Configuration 1 to Configuration 5, wherein the private charge facility is a facility for charging an electric vehicle, the system including a charge facility usage situation recognizing section that recognizes a usage situation of the private charge facility, wherein when the permission-for-use condition is established and the charge facility usage situation recognizing section recognizes that there is a vacant parking space for using the private charge facility, the permission-for-charge-facility-use determining section transmits the permission-for-use information to the user terminal.

According to the charge support system of Configuration 6, when there is a vacant parking space and the electric vehicle can be parked to be charged with the charge facility, the permission-for-use information can be transmitted to the user terminal to permit the applicant for use to use the charge facility.

(Configuration 7) A charge support method executed by a computer, the method including: a manager information acquiring step of accessing a manager database that stores manager information as information regarding a manager of a private charge facility to acquire the manager information; an applicant-for-use information acquiring step of accessing a user database that stores applicant-for-use information as information regarding an applicant for use who wants to use the private charge facility to acquire the applicant-for-use information; and a permission-for-charge-facility-use determining step of determining whether or not a predetermined permission-for-use condition is established between the applicant for use and the manager based on the applicant-for-use information and the manager information upon receipt of application-for-charge-facility-use information from a user terminal used by the applicant for use, the application-for-charge-facility-use information being for applying for use of the private charge facility, and of transmitting permission-for-use information to the user terminal when the permission-for-use condition is established, the permission-for-use information being for making notification of permission for use of the private charge facility.

By executing the charge support method of Configuration 7 with a computer, there can be obtained the similar operation and effects to those of the charge support system of Configuration 1.

### REFERENCE SIGNS LIST

1 Charge support system
10 Processor
11 Manager information acquiring section
12 Applicant-for-use information acquiring section
13 Permission-for-charge-facility-use determining section
14 Charge facility usage situation recognizing section
20 Memory
21 Program
50 House
51 Private charge facility
52 Parking space
53 Electric vehicle of a manager (second electric device)
55 Manager terminal
60 Electric vehicle of an applicant for use (first electric device)
61 Battery
65 User terminal
100 Communication network
110 Management server of a manufacturer A (provider)
111 Manager DB
112 User DB
U Applicant for use
M Manager (of a private charge facility)

What is claimed is:

1. A charge support system comprising:
a manager information acquiring section that accesses a manager database that stores manager information as information regarding a manager of a private charge facility to acquire the manager information;
an applicant-for-use information acquiring section that accesses a user database that stores applicant-for-use information as information regarding an applicant for use who wants to use the private charge facility to acquire the applicant-for-use information; and
a permission-for-charge-facility-use determining section that determines whether or not a predetermined permission-for-use condition is established between the applicant for use and the manager based on the applicant-for-use information and the manager information upon receipt of application-for-charge-facility-use information from a user terminal used by the applicant for use, the application-for-charge-facility-use information being for applying for use of the private charge facility, and that transmits permission-for-use information to the user terminal when the permission-for-use condition is established, the permission-for-use information being for making notification of permission for use of the private charge facility.

2. The charge support system according to claim 1, wherein
the applicant-for-use information includes information of a provider of a first electric device that the applicant for use wants to charge with the private charge facility,
the manager information includes information of a provider of the private charge facility or a second electric device that is used by the manager, and
the permission-for-use condition to the effect that the provider of the first electric device and the provider of the private charge facility or the second electric device are identical is set.

3. The charge support system according to claim 1, wherein
the applicant-for-use information includes identification information of the applicant for use,
the manager information includes identification information of a subject person that the manager has previously permitted to use the private charge facility, and
the permission-for-use condition to the effect that the identification information of the applicant for use coincides with the identification information of the subject person that the manager has previously permitted to use the private charge facility is set.

4. The charge support system according to claim 1, wherein
the applicant-for-use information includes an attribute of the applicant for use,
the manager information includes an attribute of the manager, and
the permission-for-use condition to the effect that at least one element is common to the attribute of the applicant for use and the attribute of the manager is set.

5. The charge support system according to claim 1, wherein
the application-for-charge-facility-use information includes information of a place where the applicant for use is positioned,
the manager information includes information of a place where the private charge facility is installed, and
the permission-for-charge-facility-use determining section determines whether or not the permission-for-use condition is established with the private charge facility that is installed at a place within a predetermined distance from the place where the applicant for use is positioned being as a target.

6. The charge support system according to claim 1, wherein
the private charge facility is a facility for charging an electric vehicle, the system comprising
a charge facility usage situation recognizing section that recognizes a usage situation of the private charge facility, wherein
when the permission-for-use condition is established and the charge facility usage situation recognizing section recognizes that there is a vacant parking space for using the private charge facility, the permission-for-charge-facility-use determining section transmits the permission-for-use information to the user terminal.

7. A charge support method executed by a computer, the method comprising:
a manager information acquiring step of accessing a manager database that stores manager information as information regarding a manager of a private charge facility to acquire the manager information;
an applicant-for-use information acquiring step of accessing a user database that stores applicant-for-use information as information regarding an applicant for use who wants to use the private charge facility to acquire the applicant-for-use information; and
a permission-for-charge-facility-use determining step of determining whether or not a predetermined permission-for-use condition is established between the applicant for use and the manager based on the applicant-for-use information and the manager information upon receipt of application-for-charge-facility-use information from a user terminal used by the applicant for use, the application-for-charge-facility-use information being for applying for use of the private charge facility, and of transmitting permission-for-use information to the user terminal when the permission-for-use condition is established, the permission-for-use information being for making notification of permission for use of the private charge facility.
